(19) United States
(12) Patent Application Publication
(10) Pub. No.: US 2005/0122464 A1
(43) Pub. Date: Jun. 9, 2005

(54) One-drop fill spacerless process for liquid crystal cell on a silicon backplane or microdisplays

(75) Inventor: Minhua Lu, Mohegan Lake, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: INTERNATIONAL BUSINESS MACHINES CORPORATION, ARMONK, NY (US)

(21) Appl. No.: 10/726,942

(22) Filed: Dec. 3, 2003

(51) Int. Cl. G02F 1/1339

(52) U.S. Cl. 349/190; 349/156

(57) ABSTRACT

A method and an arrangement for the spacerless dispensing of precise amounts of liquid crystals into cells to form active liquid crystal display areas on silicon backplane or microdisplays. There is implemented a unique spacerless manufacture of miniature liquid crystal displays (LCD's), particularly at the wafer level in that, subsequent to imparting the active elements and mirrors on a silicon wafer, there is formed a completely enclosed spacer wall, preferably by photolithographic applications, along a peripheral wall region extending externally of the active display area and leaving a narrow space for a sealant externally of the spacer wall. Thereafter, an alignment layer is applied to the wafer, and a covering glass, which is of similar size and configuration, is provided in order to cover the entire active area of the wafer. Thereafter, the sealant is dispensed in the sealant region outside of the spacer wall extending about the liquid crystal areas, which may contain discrete spacer balls or posts, and thereafter lamination implemented under a vacuum, and the sealant is cured.

### BACKGROUND OF THE INVENTION

The present invention relates to a method and to an arrangement for the spacerless filling of liquid crystals to form liquid crystal cells on silicon backplane or microdisplays.

The employment of microdisplays, which essentially are miniature displays deployed in non-direct viewing devices, such as head mount displays (HED), viewfinders and projection displays is widely known in the technology. Ordinarily, such microdisplays are of minute dimensions, frequently less than one inch, as measured in a diagonal, and at times may even be smaller than a surface measuring one centimeter by one centimeter (1 cm×1 cm). The microdisplays generally employ liquid crystals whereby these may be both of selectively the transmissive and reflective types of liquid crystal displays (LCD's). Thus, for instance, the reflective liquid crystal display is based on a buildup on a silicon backplane or substrate (LCOS) so as to serve as an active matrix in order to address the pixels, as well as the driver and controller of the displays. Such liquid crystals on silicon backplane (LCOS) displays represent one of the most commonly contemplated applications in the technology due to the availability of high aperture ratio, high resolution, small size, and highly integrated nature thereof. Furthermore, inasmuch as the LCOS displays are based on being built upon silicon, the reduction which is attained in the size of the display or the area of the silicon is an important aspect in attempting to lower the cost of fabricating the displays.

Hereby, due to the differences in the mechanical properties of the substrates which are employed in the manufacture of the LCOS, such as glass windows that are laminated to the silicon backplane, obtaining control over cell gap uniformity is necessary in carrying out the LCOS display manufacture.

Although numerous attempts have been made in industry and in the technology to laminate glass windows to silicon backplanes at the whole wafer level of fabrication, prior to separation or slicing the wafer into individual liquid crystal display cells, there is encountered the burden of a large extent of waste due to damage which is encountered during the manufacturing process. Generally, cutting or dicing of the wafer into individual dies prior to implementing of the LCD processes, as is currently employed in the technology, causes production problems due to the small sizes of the displays, during the manipulation or handling of the components, the time required for processing and the yield of satisfactory individual liquid crystal displays in comparison with the quantity thereof, which must be discarded during production as being unsatisfactory in nature.

Moreover, inasmuch as microdisplays are generally viewed under conditions of magnification, a spacer which is employed in order to control the cell gap, may readily appear to a viewer as a defect on the liquid crystal display screen.

In addition to the foregoing difficulties which are frequently encountered during manufacture of the individual liquid crystal display cells, the miniature sizes of the displays renders any glue seal to be positioned in very close proximity to the active liquid crystal display area, and, consequently, the probabilities of potential contamination of the displays are much greater than those in direct viewer displays. Moreover, due to the mismatching of the mechanical properties between the silicon backplanes and glass windows, the stringent requirements which are necessary for cell gap uniformity, renders the production even more difficult inasmuch as when the displays employed for projection applications, the provision of spacers, which are utilized to control cell gaps, and which may be either random ball spacers or irregularly arranged spacer posts, are rendered visible to a viewer and, consequently, degrade the quality of the image of the displays, since the displays are viewed under magnified conditions, rendering their presence even more prevalent.

Although various aspects of providing miniature liquid crystal cell assemblies and displays have been addressed by the technology, these do not solve the problems pursuant to the present invention.

### DISCUSSION OF THE PRIOR ART

Lovas, et al., U.S. Pat. No. 6,126,768, which is commonly assigned to the present assignee, and the disclosure of which is incorporated herein by reference, provides for a method of assembling a liquid crystal display, wherein a plurality of spacers are positioned in the area of the sealing member employed between substrates, which are to be laminated. A frame is then positioned externally of each substrate, and the frame is aligned with the sealing member. Pressure is then applied to each frame so that a region corresponding to a display area is substantially pressure-free, and a uniform cell gap is obtained. However, the presence of spacers may adversely affect the integrity of the display area when subjected to magnification in non-direct viewing devices used in projections.

Brosig, et al., U.S. Pat. No. 5,106,441, discloses a method and a jig for liquid crystal display (LCD) manufacture, which also employs the positioning of spacers to form gaps between the individual liquid crystal display cells. Again, this may lead to a degrading in the image of the liquid crystal display, when the latter is utilized in projection applications, such as with head mount displays, viewfinders and in other instances of magnification of the display area.

### SUMMARY OF THE INVENTION

Accordingly, in order to obviate or ameliorate the limitations and drawbacks which are encountered in the manufacture liquid crystal displays in the prior art, pursuant to the present invention there is provided an essentially spacerless method and arrangement for a so called one-drop filling of liquid crystals on silicon backplanes or substrates or for microdisplays. In order to attain the foregoing, there is implemented a unique spacerless manufacture of miniature liquid crystal displays (LCD's), particularly at the wafer level in that, subsequent to imparting the active elements and mirrors on a silicon wafer, there is formed a completely enclosed spacer wall, preferably by photolithographic applications, along a peripheral wall region extending externally of the active display area and leaving a narrow space for a sealant externally of the spacer wall. Thereafter, an alignment layer is applied to the wafer, and a covering glass, which is of similar size and configuration, is provided in order to cover the entire active area of the wafer. Thereafter, the sealant is dispensed in the sealant region outside of the spacer wall extending about the liquid crystal areas, and the exact amount of liquid crystal is then dispensed into these areas within the wall areas, and thereafter the covering glass and the wafer are laminated together under a vacuum, and the sealant is cured.

The inventive method basically provides a two-fold advantageous effect in that, in a first instance, there is prevented any sealant from contacting the liquid crystals, particularly, in the uncured condition of the sealant, thereby eliminating any source of contamination of the liquid crystals. Moreover, in a second instance, the walls serve as a spacer defining the cell gap, in effect, the spacing between the glass and the silicon substrate, and by combining a one-drop fill with a spacerless assembly, cell gap uniformity is more readily controlled, inasmuch as the liquid crystal, which is filled in the gap, provides an improved support to any substrates defined by the silicon and the glass.

Thereafter, the wafer can be sliced in a die boundary externally of the spacer walls encompassing each of the liquid crystal displays, and by also cutting through the sealant material without in any manner adversely affecting the quality of the liquid crystal display, particularly, in the absence of any spacers in the form of spacer balls or posts located within the active display field.

### BRIEF DESCRIPTION OF THE DRAWINGS

Reference may now be made to the following detailed description of a preferred embodiment of the invention, taken in conjunction with the accompanying drawings; in which:

FIG. 1 diagrammatically illustrates prior art arrangement, shown in vertical cross-section, of a single die liquid crystal display cell assembly;

FIG. 2 illustrates a diagrammatic representation, similar to FIG. 1, of a multi-cell assembly, shown with empty liquid crystal display cells;

FIG. 3 illustrates, diagrammatically, a plan view of a wafer showing the structure thereof for the spacerless dicing of a wafer into individual liquid crystal cells; and

FIG. 4 illustrates, diagrammatically, a representation of the multi-cell liquid crystal display formed pursuant to the present invention.

### DETAILED DESCRIPTION OF A PREFERRED EMBODIMENT

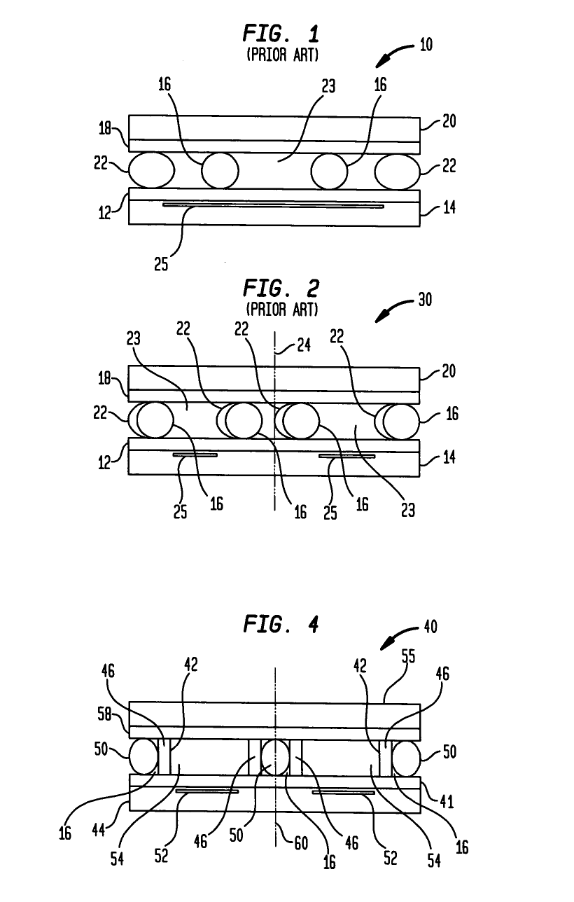

Referring now in more specific detail to the drawings, as shown in the prior art representation of FIG. 1, there is illustrated a single liquid crystal display cell assembly 10 showing the manufacture thereof pursuant to the prior art. In this case, an alignment layer 12 is positioned on a TFT substrate or silicon die 14, and a sealant 22 is applied to the perimeter of the single cell, the latter of which is equipped with spacer balls or posts 16. An upper alignment layer 18 is then positioned on the spacer balls or posts 16 and a glass window layer 20 positioned thereon. During assembly, air is provided and then liquid crystal 23 is filled into the cell, producing active liquid crystal display area 25, whereupon curing of sealant 22 is effected.

As illustrated in FIG. 2 of the drawings, this illustrates a prior art liquid crystal cell-forming method, in which the components are analogous to those of FIG. 1, and identified by the same reference numerals. However, in this instance, this is a multi-cell assembly 30 showing a plurality of spacer posts or balls 16 providing a spacer arrangement with a scribe line 24 being included therebetween in order to separate the components into more than one liquid crystal cell. This, however, illustrates that the cell was empty, and the cavity was under a vacuum during assembly, or was filled with air after assembly of the components. The presence of such a cavity results in difficulties in exerting control over cell gap uniformity. Moreover, the handling, filling and sealing of the minutely-sized liquid crystal displays is a labor-intensive and resultingly expensive task.

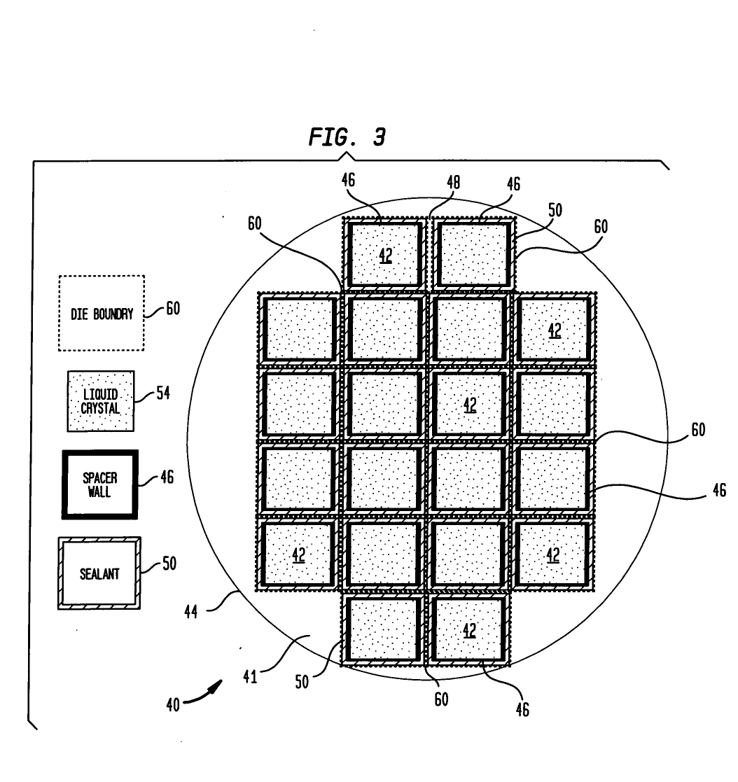

In contrast with the foregoing, pursuant to the present invention, which is deemed to obviate the disadvantages or drawbacks encountered in the prior art, in this instance, as shown in FIG. 3 of the drawings, there is shown a plan view of a wafer 40 having an alignment layer 41 and having thereon multiple miniature or small sized liquid crystal display cells 42, preferably each of less than one inch diagonal in size, or within range of 4 mm×4 mm to about 4 cm×5 cm, as may be desired for projection viewing. In this instance, a bottom backplane or substrate of silicon 44 has an array of spacer walls 46 formed thereon, such as by lithography, which define a liquid crystal area each being a cell 42 therebetween, as encompassed by each respective, (in this instance rectangular) spacer wall structure 46.

The external narrow spaces 48, which are present between the adjacent mutually facing spacer walls 46 are filled with a curable liquid sealant 50, whereas the interior liquid crystal display area 52 of each cell formed by a respective spacer wall rectangle 46, is provided with a liquid crystal drop 54 filling cell 42.

Thereafter, as shown in FIG. 4 of the drawings, the arrangement is covered with a window-forming glass pane 55 of essentially the size of the silicon substrate wafer 40, with the glass having an alignment layer 58 facing the walls 46 thereon, and pressure is applied to laminate the cells and to provide a cure of the sealant 50 filling the gaps between the external proximate spacer wall surfaces. Thereafter, the die boundaries 60 between the walls 46 in spaces 48 for each of the liquid display cells 42 may be diced so as to provide individual separated liquid crystal cells. This enables cells to be formed without necessitating the provisions of any spacers in the form of balls or posts 16 to be arranged within the active liquid crystal display area 52, and whereby the spacer walls 46 prevent any sealant 50, particularly uncured sealant, from contacting the liquid crystals, thereby eliminating any source of contamination of the latter. Furthermore, the external surfaces of the spacer walls 46 providing the narrow gaps 48 filled with sealant 50 each serve as a cell gap and enable a more uniform cell gap control, inasmuch as the liquid crystal is filled interiorly, so as to provide an improved support for the silicon substrate during the filling procedure. It is also possible to selectively apply pressure to the spacer walls 46 during lamination and sealant curing in order to ensure improved cell gap uniformity. A further advantage resides in that the spacer walls 46 may be of a relatively thin construction, such as of a thickness of 5 to 500 μm or less. This can also prevent further contamination of the liquid crystals. It is also possible to arrange a plurality of discretely spaced spacer balls or posts 16 in the areas which contain the sealant 50 so as to thereby further strengthen the mechanical structure of the display. The peripheral area about each cell can also be further reduced in that manner and the overall silicon die area can also be correspondingly reduced in size.

While the present invention has been particularly shown and described with respect to preferred embodiments thereof, it will be understood by those skilled in the art that the foregoing and other changes in forms and details may be made without departing from the scope and spirit of the present invention. It is therefore intended that the present invention not be limited to the exact forms and details described and illustrated, but fall within the scope of the appended claims.

1. A method for the spacerless filling of liquid crystals to form liquid crystal cells on a silicon backplane or microdisplays, said method comprising:
forming spacer walls on said silicon backplane to provide a plurality of cells surrounding active liquid crystal display areas;
dispensing into each of said active liquid crystal display areas within spacer walls with an exact amount of liquid crystals;
introducing a curable sealant into gaps externally of said spacer walls;
laminating a top layer material to said silicon backplane; and
curing said sealant and dicing said silicon backplane through said gaps so as to form individual liquid crystal-filled cells.

2. A method as claimed in claim 1, wherein said silicon backplane comprises a semiconductor wafer having said liquid crystal cells formed thereon in a closely spaced array.

3. A method as claimed in claim 2, wherein said spacer walls are configured to form essentially rectangular liquid crystal cells.

4. A method as claimed in claim 3, wherein said liquid crystal cells each have dimensions within a range of about 4 mm×4 mm to 5 cm×5 cm in size.

5. A method as claimed in claim 1, wherein said top layer material comprises a glass window of a size commensurate with the size of said silicon backplane.

6. A method as claimed in claim 1, wherein said spacer walls are formed lithographically on said silicon backplane.

7. A method as claimed in claim 1, wherein pressure is selectively applied to said spacer walls during introduction of said sealant into said gaps so as to facilitate control over the uniformity of said gaps about the liquid crystal cells and to provide a support for the silicon backplane during the assembly of said cells.

8. A method as claimed in claim 1, wherein each of said spacer walls has a thickness within the range of about 5 to 500 μm.

9. A method as claimed in claim 1, wherein the surfaces of said silicon backplane and of said top layer material facing said spacer walls are each provided with a layer of an alignment material.

10. A method as claimed in claim 1, wherein the dispensing of said liquid crystals and sealant and lamination are implemented under a vacuum.

11. A method as claimed in claim 1, wherein the discrete spacer posts or balls are arranged in the areas containing said sealant so as to mechanically strengthen said liquid crystal displays.

12. An arrangement for the spacerless filling of liquid crystals to form liquid crystal cells on a silicon backplane or microdisplays, said arrangement comprising:
spacer walls being formed on said silicon backplane to provide a plurality of cells surrounding active liquid crystal display areas;
precise amounts of liquid crystals being dispensed into each of said enclosed active liquid crystal display areas within enclosing spacer walls;
a curable sealant being introduced into gaps externally of said spacer walls;
a top layer material being laminated to said silicon backplane; and
said sealant being cured and said silicon backplane being diced through said gaps so as to form individual liquid crystal-filled cells.

13. An arrangement as claimed in claim 12, wherein said silicon backplane comprises a semiconductor wafer having said liquid crystal cells formed thereon in a closely spaced array.

14. An arrangement as claimed in claim 13, wherein said spacer walls are configured to form essentially rectangular liquid crystal cells.

15. An arrangement as claimed in claim 14, wherein said liquid crystal cells each have dimensions within a range of about 4 mm×4 mm to 5 cm×5 cm in size.

16. An arrangement as claimed in claim 12, wherein said top layer material comprises a glass window of a size commensurate with the size of said silicon backplane.

17. An arrangement as claimed in claim 12, wherein said spacer walls are formed lithographically on said silicon backplane.

18. An arrangement as claimed in claim 12, wherein pressure is selectively applied to said spacer walls during introduction of said sealant into said gaps so as to facilitate control over the uniformity of said gaps about the liquid crystal cells and to provide a support for the silicon backplane during the assembly of said cells.

19. An arrangement as claimed in claim 12, wherein each of said spacer walls has a thickness within the range of about 5 to 500 μm.

20. An arrangement as claimed in claim 12, wherein the surfaces of said silicon backplane and of said top layer material facing said spacer walls are each provided with a layer of an alignment material.

21. An arrangement as claimed in claim 12, wherein the dispensing of said liquid crystals and sealant and lamination are implemented under a vacuum.

22. An arrangement as claimed in claim 12, wherein discrete spacer balls or posts are arranged in the areas containing said sealant for mechanical strengthening of said liquid crystal displays.
